(19) United States
(12) Patent Application Publication
(10) Pub. No.: US 2021/0371132 A1
(43) Pub. Date: Dec. 2, 2021

(54) VEHICLE PROPULSION CONTROL SYSTEMS, VEHICLES INCLUDING THE SAME, AND ASSOCIATED METHODS OF REGULATING THE OPERATION OF A PLURALITY OF ENGINES OF A VEHICLE

(71) Applicant: The Boeing Company, Chicago, IL (US)

(72) Inventors: Timothy Ip, Edmonds, WA (US); Kent E. Karnofski, Seattle, WA (US)

(21) Appl. No.: 16/888,159

(22) Filed: May 29, 2020

(51) Int. Cl. B64F 5/60; F02D 25/00; F02D 29/02; F02C 6/20; F02C 9/00; B64D 31/02; G01M 15/14

(52) U.S. Cl. CPC B64F 5/60; F02D 25/00; F02D 29/02; F02C 6/20; F05D 2270/13; B64D 31/02; G01M 15/14; F05D 2220/323; F02C 9/00

(57) ABSTRACT

Vehicle propulsion control systems, vehicles including the same, and associated methods. A method of regulating the operation of a plurality of engines of a vehicle includes, for each of the plurality of engines, receiving engine status information, assigning an engine health score, and assigning an engine status identifier. The method further includes comparing the operational fitness of two or more engines and modulating an operational configuration of one or more engines. In examples, a vehicle propulsion control system for controlling the operation of a plurality of engines of a vehicle includes a propulsion executive controller (PEC) and a plurality of electronic engine controllers (EECs) that control the operation of respective engines. The PEC is configured to generate and transmit an engine action signal for controlling the operation of the one or more respective engines. In some examples, an aircraft includes a plurality of engines and the vehicle propulsion control system.

### FIELD

The present disclosure relates to vehicle propulsion control systems, vehicles including the same, and associated methods of regulating the operation of a plurality of engines of a vehicle.

### BACKGROUND

Vehicle propulsion control systems for vehicles that include a plurality of engines may be configured to modulate the operation of one or more such engines based upon a sensed and/or measured operational status of the engines. However, in such examples, the modulation of the operation of a given engine may depend only upon the operational status of the given engine. Thus, in such examples, such vehicle propulsion control systems may produce an operational configuration that is locally optimized for each engine but that is sub-optimal for the performance of the vehicle as a whole.

### SUMMARY

Vehicle propulsion control systems, vehicles including the same, and associated methods of regulating the operation of a plurality of engines of a vehicle are disclosed herein. A method of regulating the operation of a plurality of engines of a vehicle includes, for each respective engine of the plurality of engines, receiving engine status information regarding an operational status of the respective engine, assigning an engine health score for the respective engine, and assigning an engine status identifier for the respective engine. The engine health score quantifies an operational fitness of the respective engine based, at least in part, on the engine status information. The engine status identifier at least partially represents the current operational state of the respective engine based, at least in part, on the engine status information. The method further includes comparing the operational fitness of two or more engines based, at least in part, on the engine health scores of each of the two or more engines, and modulating an operational configuration of one or more engines based, at least in part, on the comparing the operational fitness of the two or more engines. The comparing the operational fitness of the two or more engines includes comparing the engine health scores of each of the two or more engines.

In some examples, a vehicle propulsion control system for controlling the operation of a plurality of engines of a vehicle includes a propulsion executive controller (PEC) configured to execute at least a portion of methods according to the present disclosure. The vehicle propulsion control system additionally includes a plurality of electronic engine controllers (EECs) that control the operation of respective engines. In such examples, the PEC is configured to generate and transmit an engine action signal for controlling the operation of the one or more respective engines to each EEC based, at least in part, on the respective health scores of two or more engines. In some examples, an aircraft includes a plurality of engines and the vehicle propulsion control system.

### BRIEF DESCRIPTION OF THE DRAWINGS

FIG. 1 is a schematic representation of examples of vehicles including vehicle propulsion control systems according to the present disclosure.

FIG. 2 is a schematic representation of examples of aircraft including engines and vehicle propulsion control systems according to the present disclosure.

FIG. 3 is a flowchart depicting examples of methods of regulating the operation of a plurality of engines of a vehicle according to the present disclosure.

### DESCRIPTION

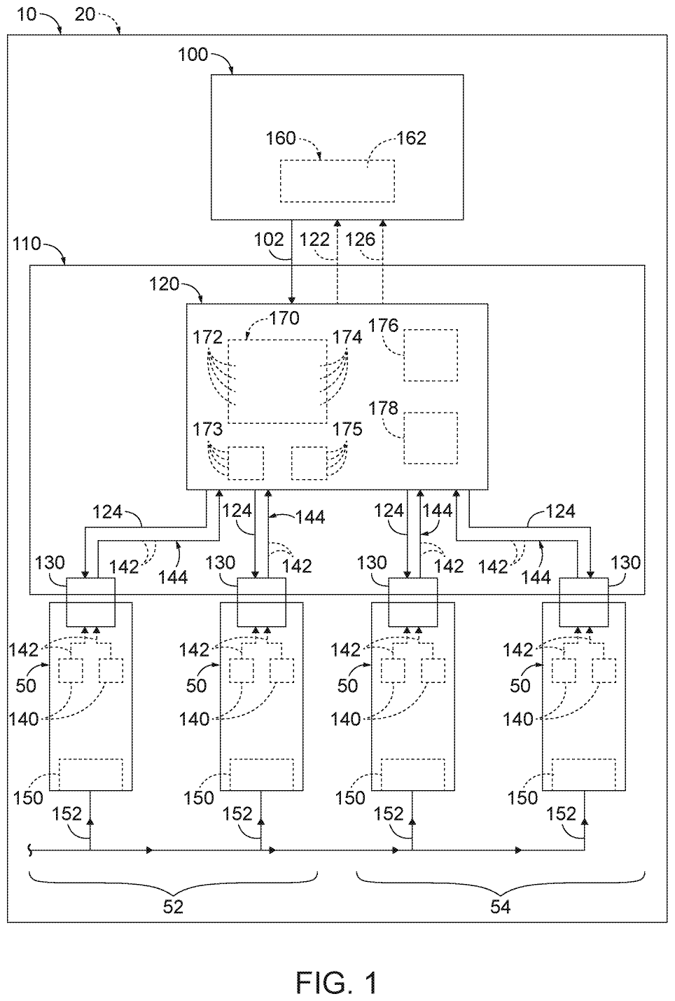

FIGS. 1-3 provide illustrative, non-exclusive examples of vehicle propulsion control systems 110, of vehicles 10 including engines 50 and vehicle propulsion control systems 110, and/or of methods 200 of regulating the operation of a plurality of engines 50 of vehicle 10, according to the present disclosure. Elements that serve a similar, or at least substantially similar, purpose are labeled with like numbers in each of FIGS. 1-3, and these elements may not be discussed in detail herein with reference to each of FIGS. 1-3. Similarly, all elements may not be labeled in each of FIGS. 1-3, but reference numerals associated therewith may be utilized herein for consistency. Elements, components, and/or features that are discussed herein with reference to one or more of FIGS. 1-3 may be included in and/or utilized with any of FIGS. 1-3 without departing from the scope of the present disclosure. Generally, in the Figures, elements that are likely to be included in a given example are illustrated in solid lines, while elements that are optional to a given example are illustrated in dashed lines. However, elements that are illustrated in solid lines are not essential to all examples of the present disclosure, and an element shown in solid lines may be omitted from a particular example without departing from the scope of the present disclosure.

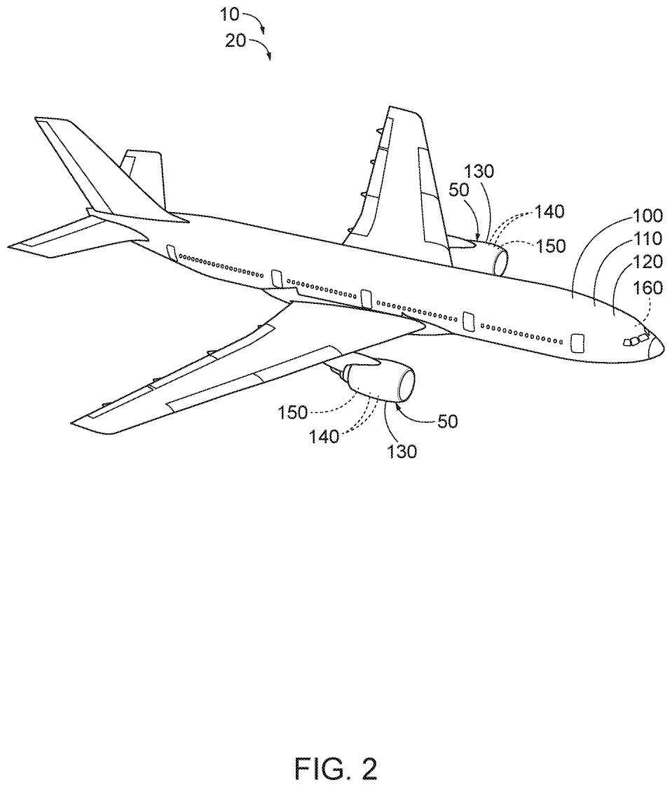

FIG. 1 is a schematic representation of a vehicle 10 according to the present disclosure. As schematically illustrated in FIG. 1, vehicle 10 includes a plurality of engines 50 and a vehicle propulsion control system 110 for regulating the operation of engines 50, as described herein. Vehicle 10 may include and/or be any appropriate vehicle that utilizes a plurality of engines 50. In some examples, and as described herein and as illustrated in FIG. 2, vehicle 10 is an aircraft 20. Specifically, in the examples of FIG. 2, each engine 50 is a turbofan engine. However, this is not required of all examples of aircraft 20 and/or of vehicles 10, and it is additionally within the scope of the present disclosure that engine 50 of aircraft 20 may be any suitable aircraft engine, such as a propeller engine and/or a jet engine that is not a turbofan engine. Additionally, while the present disclosure generally relates to examples in which vehicle 10 is an aircraft 20, this is not required, and it is additionally within the scope of the present disclosure that vehicle propulsion control systems 110 and/or methods 200 may be utilized in conjunction with any appropriate vehicle 10. For example, vehicle propulsion control systems 110 and/or methods 200 according to the present disclosure may be implemented in any vehicular application. As more specific examples, vehicle propulsion control systems 110 and/or methods 200 may be implemented in any marine, ground, air, and/or space application, and in any vehicular or non-vehicular system, subsystem, assembly, subassembly, structure, building, machine, or application that utilizes a plurality of engines or other motive devices to propel a movable device. In this manner, vehicle propulsion control systems 110 and/or methods 200 according to the present disclosure may be implemented and/or utilized in any one of a variety of different applications in any industry, without limitation.

As described herein, vehicle propulsion control system 110 generally is configured to at least partially control the operation of engines 50 via comparison of the respective operational states and/or operational fitness of engines 50. More specifically, and as described in more detail herein, when one or more engines 50 are experiencing respective degraded performance conditions, vehicle propulsion control system 110 is configured to assess the performance of a plurality of engines 50 and to modulate the operational configuration of one or more engines 50 to optimize the collective performance of the plurality of engines 50. In this manner, vehicle propulsion control systems 110 and/or methods 200 according to the present disclosure may be described as representing systems and methods corresponding to decision-making routines that are at least semi-autonomous, such as to inform and/or replace flight crew decision making. As described in more detail herein, such systems and methods may serve to address such practical operational considerations as: In the case of an engine experiencing degraded performance, should the engine thrust setting be reduced, and/or should the engine be shut down? If a vehicle requires additional thrust, what is the optimal way to distribute the thrust command across the operative engines based upon their respective performance states? Should an engine be restarted after previously being shut down? When a vehicle operates under the power of an engine that is experiencing degraded performance, should the vehicle continue to its planned destination or divert to a closer destination?

As described herein, vehicle propulsion control systems 110 and/or methods 200 performed by such vehicle propulsion control systems 110 may be of particular utility in examples in which vehicle 10 is partially and/or fully autonomous. As an example, and as schematically illustrated in FIGS. 1-2, vehicle 10 additionally may include a vehicle control director 100 for at least partially controlling the operation of vehicle propulsion control system 110. In some such examples, vehicle propulsion control system 110 is configured to automatically assess and/or control operation of engines 50 responsive to a command input received from vehicle control director 100. In an example in which vehicle 10 is fully autonomous, vehicle control director 100 also is fully automated. Alternatively, in an example in which vehicle 10 is at least partially controlled by a human operator, vehicle control director 100 may be configured to provide information to the human operator and/or to receive an input from the human operator regarding operation of vehicle 10. In some such examples, and as schematically illustrated in FIGS. 1-2, vehicle control director 100 includes an engine-indicating and crew-alerting system (EICAS) 160 that is configured to provide information to the human operator regarding operation of the plurality of engines 50. In some such examples, and as schematically illustrated in FIG. 1, EICAS 160 includes a user interface 162 for presenting information to the human operator and/or for receiving an input from the human operator.

As schematically illustrated in FIGS. 1-2, vehicle propulsion control system 110 includes a propulsion executive controller (PEC) 120 for executing at least a portion (e.g., a subset) of methods 200 according to the present disclosure, discussed below. Additionally, and with further reference to FIGS. 1-2, vehicle propulsion control systems 110 and methods 200 according to the present disclosure generally relate to examples in which vehicle 10 includes a plurality of electronic engine controllers (EECs) 130 for controlling the operation of respective engines 50. That is, each EEC 130 of the plurality of EECs 130 is configured to at least partially control the operation of a respective engine 50 of the plurality of engines 50. As schematically illustrated in FIG. 1, each engine 50 may be described as including a respective EEC 130 of the plurality of EECs 130. For example, each EEC 130 may be structurally integrated with, mounted to, contained within, and/or otherwise operatively associated with the respective engine 50. In some examples, and as further schematically illustrated in FIG. 1, vehicle propulsion control system 110 may be described as including the plurality of EECs 130.

As described in more detail herein, each EEC 130 is configured to transmit information to PEC 120 and/or to receive commands from PEC 120 regarding the operation of the respective engine 50. Specifically, in some examples, and as schematically illustrated in FIG. 1 and discussed in more detail below, PEC 120 is configured to generate and transmit a respective engine action signal 124 to each EEC 130 to control the operation of the corresponding engine 50, More specifically, in such examples, and as discussed herein, PEC 120 is configured to generate each engine action signal 124 at least partially based on the respective operational conditions of two or more engines 50. In this manner, and as discussed herein, PEC 120 may be configured to transmit a respective engine action signal 124 to a respective EEC 130 at least partially based upon the operational condition of one or more engines 50 of vehicle 10 that are not controlled by the respective EEC 130.

In some examples, and as schematically illustrated in FIGS. 1-2, vehicle 10 additionally includes one or more engine sensors 140 for detecting an operational characteristic of one or more respective engines 50. Specifically, in such examples, each engine sensor 140 is configured to detect a respective operational characteristic of one or more respective engines 50 and to generate and transmit a respective sensor data signal 142 that at least partially characterizes the respective operational characteristic. More specifically, in such examples, and as schematically illustrated in FIG. 1, each engine sensor 140 is configured to transmit the respective sensor data signal 142 to PEC 120. In some such examples, and as schematically illustrated in FIG. 1, each engine sensor 140 is configured to transmit the respective sensor data signal 142 to PEC 120 via EEC 130 of the respective engine 50. However, this is not required of all examples of vehicle propulsion control system 110, and it is additionally within the scope of the present disclosure that each engine sensor 140 may transmit the respective sensor data signal 142 directly to PEC 120.

In some examples, and as schematically illustrated in FIGS. 1-2, vehicle 10, each engine 50, and/or vehicle propulsion control system 110 includes one or more fuel control units 150 for regulating a respective fuel flow 152 to each respective engine 50. In some such examples, and as schematically illustrated in FIG. 1, each engine 50 includes a respective fuel control unit 150 for regulating fuel flow 152 to that engine 50. As described in more detail herein, vehicle propulsion control system 110 and/or PEC 120 may be configured to control the operation of each fuel control unit 150 to at least partially control the operation of each respective engine 50.

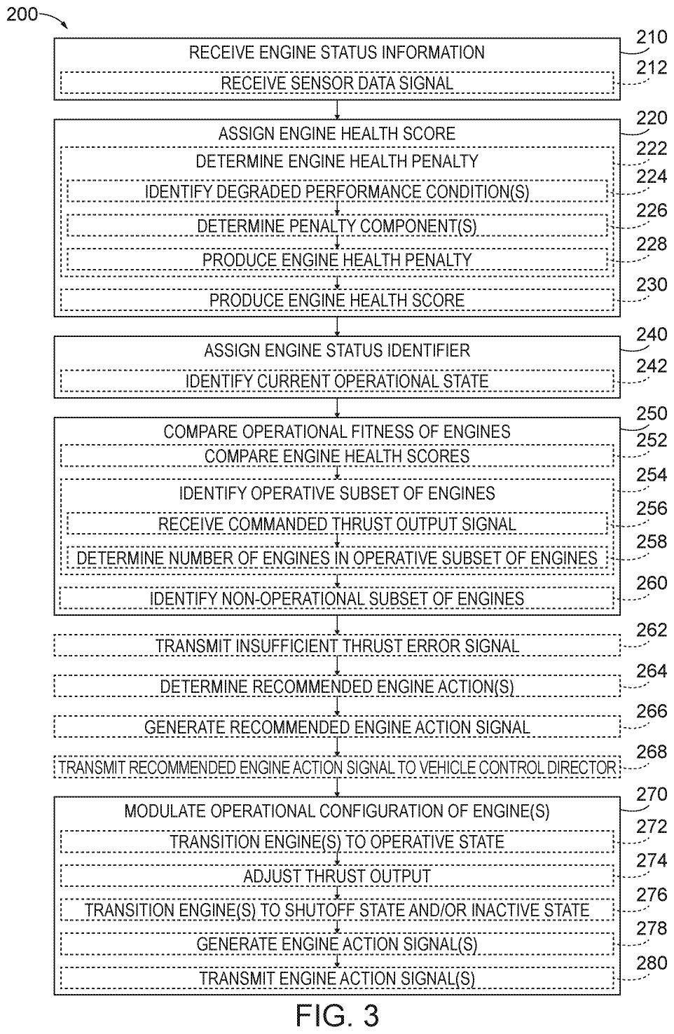

FIG. 3 is a flowchart depicting examples of methods 200, according to the present disclosure, of regulating the operation of a plurality of engines of a vehicle, such as engines 50 of vehicle 10 as schematically illustrated in FIGS. 1-2. In this manner, FIGS. 1-2 may be described as schematically depicting aspects of methods 200 and/or of components utilized to perform methods 200. However, the schematic representations of FIGS. 1-2 are not limiting, and it is within the scope of the present disclosure that methods 200 may be performed by and/or in conjunction with any appropriate systems and components. As examples, methods 200 may be performed by and/or in conjunction with at least a subset of the components that are schematically illustrated in FIGS. 1-2, components functionally analogous to those schematically illustrated in FIGS. 1-2, and/or additional or alternative components relative to those schematically illustrated in FIGS. 1-2. Additionally, while methods 200 generally are discussed in conjunction with reference numerals corresponding to the schematic illustrations of FIGS. 1-2, this is not limiting, and it is additionally within the scope of the present disclosure that methods 200 may be performed in conjunction with systems and/or components other than those schematically illustrated in FIGS. 1-2.

As shown in FIG. 3, method 200 includes, for each respective engine 50 of the plurality of engines 50, receiving, at 210, engine status information regarding an operational status of the respective engine 50; assigning, at 220, an engine health score to the respective engine 50; and assigning, at 240, an engine status identifier to the respective engine 50. Examples of the engine status information, the engine health score, and/or the engine status identifier are disclosed herein with reference to engine status information 144, engine health score 172, and engine status identifier 174, respectively, as schematically illustrated in FIG. 1. In particular, and as described herein, engine health score 172 of each respective engine 50 quantifies a current operational condition and/or fitness of the respective engine 50, while engine status identifier 174 at least partially represents the current operational state of the respective engine 50. Each of engine health score 172 and engine status identifier 174 is at least partially based on engine status information 144 of the respective engine 50, as described herein.

As discussed, in some examples, PEC 120 is configured to generate and transmit a respective engine action signal 124 to each EEC 130 based on the respective operational conditions of two or more engines 50. More specifically, in some such examples, PEC 120 is configured to generate and transmit the respective engine action signal 124 to the respective EEC 130 at least partially based upon the respective engine health scores 172 of two or more engines 50. In this manner, and as discussed herein, PEC 120 may be configured to transmit a respective engine action signal 124 to a respective EEC 130 at least partially based upon engine health score(s) 172 of one or more engines 50 of vehicle 10 that are not controlled by the respective EEC 130.

As shown in FIG. 3, method 200 further includes comparing, at 250, the operational fitness of two or more engines 50 of vehicle 10 at least partially based upon the respective engine health scores 172 of the engines 50, and modulating, at 270 an operational configuration of one or more engines 50 of vehicle 10 at least partially based on the comparing the operational fitness of the two or more engines at 250.

As used herein, temporal terms such as “present,” “presently,” “current,” “currently,” and the like generally refer to, and/or are presented with reference to, an instance and/or moment in time at which method 200 (and/or a given step thereof) is being performed. For example, the current operational fitness and the current operational state of a given engine 50, as respectively represented by engine health score 172 and engine status identifier 174, refer to a state and/or configuration of the given engine 50 at the time when the assigning the engine health score at 220 and the assigning the engine status identifier at 240 are being performed. In general, such characteristics may vary in time, such as due to varying conditions and/or demands imposed upon engines 50 and/or due to the modulating the operational configuration of the engine(s) at 270. Accordingly, in some examples, methods 200 (and/or one or more steps thereof) are repeated, such as at regular intervals and/or continually, during operation of engines 50 of vehicle 10. In this manner, the systems and methods disclosed herein may be described as having utility not only to diagnose and address a collective status of the plurality of engines 50 at a moment (e.g., an instance) in time, but also to continuously monitor and update the collective status of engines 50 during operation of vehicle 10.

In some examples, and as discussed, method 200 is performed, at least in part, by a vehicle propulsion control system associated with the plurality of engines 50, such as vehicle propulsion control system 110 schematically illustrated in FIGS. 1-2. More specifically, in some examples, method 200 is performed, at least in part, by a PEC, such as PEC 120 of vehicle propulsion control system 110 as schematically illustrated in FIGS. 1-2. In some examples, method 200 is performed, at least in part, by an automated process. Stated differently, in some examples, one or more steps of method 200 are performed by the automated process. As more specific examples, and as described herein, the comparing the operational fitness of the two or more engines at 250 and/or the modulating the operational configuration of the one or more engines at 270 may be performed by the automated process.

PEC 120 may include and/or be any suitable structure, device, and/or devices that may be adapted, configured, designed, constructed, and/or programmed to perform the functions discussed herein. As examples, PEC 120 may include one or more of an electronic controller, a dedicated controller, a special-purpose controller, a special-purpose computer, a display device, a logic device, a memory device, and/or a memory device having computer-readable storage media.

The computer-readable storage media, when present, also may be referred to herein as non-transitory computer readable storage media. This non-transitory computer readable storage media may include, define, house, and/or store computer-executable instructions, programs, and/or code; and these computer-executable instructions may direct vehicle propulsion control system 110 and/or PEC 120 thereof to perform any suitable portion, or subset, of methods 200. Examples of such non-transitory computer-readable storage media include CD-ROMs, disks, hard drives, flash memory, etc. As used herein, storage, or memory, devices and/or media having computer-executable instructions, as well as computer-implemented methods and other methods according to the present disclosure, are considered to be within the scope of subject matter deemed patentable in accordance with Section 101 of Title 35 of the United States Code.

The receiving the engine status information at 210 may include receiving any appropriate information regarding the operational status of each engine 50, and may include receiving engine status information 144 from any appropriate source. In some examples, and as schematically illustrated in FIG. 1 and shown in FIG. 3, the receiving the engine status information at 210 includes receiving, at 212, a sensor data signal that is generated by an engine sensor. Examples of the engine sensor and/or the sensor data signal are disclosed herein with reference to engine sensor 140 and sensor data signal 142, respectively, as schematically illustrated in FIG. 1. Specifically, in such examples, sensor data signal 142 at least partially characterizes the current operation and/or operational characteristic of the respective engine 50. In some such examples, and as schematically illustrated in FIG. 1, engine status information 144 includes and/or is sensor data signal 142 as produced by at least one engine sensor 140. As a more specific example, and as schematically illustrated in FIG. 1, a plurality of engine sensors 140 may be associated with a given engine 50 such that engine status information 144 pertaining to the given engine 50 includes each respective sensor data signal 142 that is produced by each of the plurality of engine sensors 140 associated with the given engine 50.

In some examples, and as discussed, each engine sensor 140 is configured to transmit the respective sensor data signal 142 to PEC 120 via EEC 130. In such examples, the receiving the engine status information at 210 may include receiving sensor data signal 142 and/or engine status information 144 from EEC 130, with the receiving being performed by PEC 120. In other examples, and as described, each engine sensor 140 is configured to transmit the respective sensor data signal 142 directly to PEC 120. In such examples, the receiving the engine status information at 210 may include receiving sensor data signal 142 and/or engine status information 144 including sensor data signal 142 from engine sensor 140, with the receiving being performed by PEC 120.

Each engine sensor 140 may include and/or be any appropriate device, and may be configured to detect any appropriate operational characteristic of the respective engine(s) 50. As examples, each engine sensor 140 may include and/or be a rotational speed sensor, an air speed sensor, a temperature sensor, a vibration sensor, a pressure sensor, a microphone, a camera, an infrared camera, etc. Additionally or alternatively, each engine sensor 140 may be configured to detect and/or characterize an operational characteristic in the form of a low pressure spool speed (e.g., an N1 speed) of the respective engine 50, a high pressure spool speed (e.g., an N2 speed) of the respective engine 50, an exhaust gas temperature (EGT) of an exhaust flow exiting the respective engine 50, a radiative temperature produced by a component of the respective engine 50, a vibration magnitude of a component of the respective engine 50, an oil pressure associated with the respective engine 50, an acoustic produced by the respective engine 50, etc.

The assigning the engine health score to each respective engine at 220 may include determining and/or assigning engine health score 172 in any appropriate manner. Similarly, engine health score 172 may characterize the operational state of the respective engine 50 in any appropriate manner. In some examples, engine health score 172 of each engine 50 is numerical quantity associated with the engine, such as one-dimensional numerical quantity and/or a scalar quantity. In this manner, in such examples, the assigning the engine health score to each respective engine at 220 includes determining a numerical quantity that represents the operational state of the respective engine 50 based upon engine status information 144. As more specific examples, each engine health score 172 may be calculated, represented, and/or expressed as a number, a real number, an integer, a normalized quantity, a percentage, etc.

In some examples, engine health score 172 of each respective engine 50 is positively correlated to the operational fitness of the respective engine 50. Specifically, in the examples discussed herein, engine health score 172 is calculated such that a higher engine health score 172 corresponds to an engine 50 that is operating with a health and/or performance that is closer to an optimal performance relative to an engine 50 that is characterized by a lower engine health score 172. However, this is not required, and it is additionally within the scope of the present disclosure that engine health score 172 may be negatively correlated to the operational fitness of the respective engine 50, such that lower engine health scores 172 are closer to optimal.

In some examples, engine health score 172 of each respective engine 50 is assigned such that engine health score 172 is equal to a predetermined optimal engine health score when the respective engine 50 is fully functional and/or otherwise is operating without any known or measured faults or limitations. In some such examples, and when engine health score 172 is positively correlated to the operational fitness of the respective engine 50 and as shown in FIG. 3, the assigning the engine health score at 220 includes determining, at 222, an engine health penalty corresponding to one or more degraded performance conditions of the respective engine 50, and producing, at 230, the engine health score 172 based upon the engine health penalty and the optimal engine health score. As an example, the producing the engine health score at 230 may include subtracting the engine health penalty from the optimal engine health score to produce the engine health score. In this manner, in such examples, the engine health penalty of each respective engine 50 is a numerical quantity that is negatively correlated to the operational fitness of the respective engine 50, such that a larger quantity and/or severity of degraded performance conditions of the respective engine 50 results in a higher engine health penalty, and thus a lower engine health score 172.

As used herein, the term “degraded performance condition” is intended to refer to any appropriate condition, state, qualifier, etc. that may be used to describe and/or characterize engine 50 when engine 50 is not operating in a nominal and/or optimal performance state. In this manner, one or more degraded performance conditions according to the present disclosure may include and/or represent conditions in which engine 50 remains operable to produce thrust without damage to engine 50 and/or vehicle 10, and/or without risk to human safety. Stated differently, in an example in which vehicle 10 is an aircraft 20, engine 50 may be characterized by a degraded performance condition such that vehicle propulsion control systems 110 and/or methods 200 according to the present disclosure may be utilized to make and/or inform decisions to ensure flightworthiness of aircraft 20 and/or a capability of aircraft 20 to continue safe flight and landing.

The determining the engine health penalty at 222 may be performed in any appropriate manner, and may be based on any appropriate metrics and/or characterizations of the respective engine 50. In some examples, and as shown in FIG. 3, the determining the engine health penalty at 222 includes identifying, at 224, the one or more degraded performance conditions affecting the respective engine 50 from among a listing of a plurality of predefined degraded performance conditions, and determining, at 226, a respective penalty component associated with each of the degraded performance conditions associated with the respective engine 50. In such examples, and as shown in FIG. 3, the determining the engine health penalty at 222 subsequently includes producing, at 228, the engine health penalty by summing (e.g., arithmetically adding together) the respective penalty components associated with each of the one or more degraded performance conditions associated with the respective engine 50.

As a more specific example, and as schematically illustrated in FIG. 1, vehicle propulsion control system 110 and/or PEC 120 may include, store, and/or otherwise have access to a listing 176 of a plurality of predefined degraded performance conditions that are recognized as potentially affecting a given engine 50 in a manner that warrants decreasing engine health score 172 of the given engine 50. As examples, listing 176 of the plurality of predefined degraded performance conditions may include and/or represent an engine overheat condition, an engine surge condition, an engine fire condition, an engine damage condition, an engine oil pressure condition, a fuel leak condition, etc. Accordingly, in some examples, the identifying the degraded performance condition(s) at 224 includes identifying which of the predefined degraded performance conditions (e.g., which single degraded performance condition, or which combination of degraded performance conditions) is/are most closely associated with (e.g., most likely to result in) the engine status information 144 that was received. Stated differently, in such examples, the identifying the degraded performance condition(s) at 224 includes comparing the engine status information 144 (as received at the receiving the engine status information at 210) to the listing 176 of the plurality of predefined degraded performance conditions to identify the degraded performance condition(s) that best characterize the operational condition of the respective engine 50.

In some examples, listing 176 of the plurality of predefined degraded performance conditions further includes a listing and/or other indication of the respective penalty components associated with each predefined degraded performance condition represented in listing 176. In this manner, in such examples, the determining the respective penalty component(s) at 226 includes identifying the respective penalty components from listing 176 of the plurality of predefined degraded performance conditions. As a more specific example, the receiving the engine status information at 210 may include receiving engine status information 144 that includes and/or represents sensor data signal 142 from engine sensor 140 in the form of a rotational speed sensor that indicates that the N2 speed of the respective engine 50 is in excess of a standard operational range. Accordingly, in such an example, the determining the engine health penalty at 222 may include comparing engine status information 144 with the plurality of predefined degraded performance conditions included in listing 176 such that the identifying the degraded performance condition(s) at 224 includes identifying that the respective engine 50 is experiencing an engine surge condition. In such an example, listing 176 additionally may include a predetermined surge penalty component associated with the engine surge condition, such that the determining the respective penalty component at 226 includes identifying the predetermined surge penalty component. Because a given engine 50 may experience a plurality of degraded performance conditions at a given time, the determining the engine health penalty at 222 may include repeating the identifying the degraded performance condition(s) at 224 and the determining the respective penalty component(s) at 226 for each degraded performance condition that may be identified from engine status information 144.

The determining the respective penalty component(s) at 226 may include identifying penalty components that correspond to the plurality of predefined degraded performance conditions in any appropriate manner, such as may correspond to a classification and/or severity of the respective degraded performance condition. In some examples, listing 176 of the plurality of predefined degraded performance conditions includes a plurality of degraded performance categories, each of which includes a respective subset of the plurality of degraded performance conditions. In such examples, the penalty component associated with each respective predefined degraded performance condition is at least partially based upon the identity of the degraded performance category that includes the respective predefined degraded performance condition. As an example, the plurality of degraded performance categories may be configured such that the respective penalty component associated with each predefined degraded performance condition within a given degraded performance category is a number that is specific to the given degraded performance category and/or that is within a range of numbers that is specific to the given degraded performance category. Stated differently, in such examples, the determining the respective penalty component(s) at 226 includes identifying, for each identified degraded performance condition, the corresponding degraded performance category to which the identified degraded performance condition belongs such that the respective penalty component of each identified degraded performance condition is the number, or a number from the range of numbers, that is specific to the corresponding degraded performance category.

The plurality of degraded performance categories may characterize and/or partition the plurality of predefined degraded performance conditions in any appropriate manner. As an example, a degraded performance category may include a plurality of predefined degraded performance conditions relating to an anticipated future service lifetime of the respective engine 50 if the respective engine 50 is operated while degraded performance condition remains in effect. In such an example, the penalty component associated with each predefined degraded performance condition within this degraded performance category may be at least partially based on (e.g., negatively correlated with) the anticipated future service lifetime.

As another example, a degraded performance category may include a plurality of predefined degraded performance conditions relating to an impact of the degraded performance condition on a maximum sustained thrust that can be produced by the respective engine 50 if the respective engine 50 is operated while degraded performance condition remains in effect. In such an example, the penalty component associated with each predefined degraded performance condition within this degraded performance category may be at least partially based on (e.g., negatively correlated with) the maximum sustained thrust that may be produced.

As another example, a degraded performance category may include a plurality of predefined degraded performance conditions relating to a potential impact of the degraded performance condition on human safety if the respective engine 50 is operated while degraded performance condition remains in effect. In such an example, the penalty component associated with each predefined degraded performance condition within this degraded performance category may be at least partially based on the risk to human safety (e.g., positively correlated with the likelihood and/or magnitude of such risk).

As another example, a degraded performance category may include a plurality of predefined degraded performance conditions relating to a potential for serious damage to the respective engine 50 if the respective engine 50 is operated while degraded performance condition remains in effect. In such an example, the penalty component associated with each predefined degraded performance condition within this degraded performance category may be at least partially based on the risk of engine damage (e.g., positively correlated with the likelihood and/or magnitude of such risk).

As another example, a degraded performance category may include a plurality of predefined degraded performance conditions relating to an anticipated economic impact upon an operator of the vehicle 10 if the respective engine 50 is operated while degraded performance condition remains in effect. In such an example, the penalty component associated with each predefined degraded performance condition within this degraded performance category may be at least partially based on the anticipated economic impact (e.g., positively correlated with the likelihood and/or magnitude of such economic impact).

In all such examples, the penalty component associated with each predefined degraded performance condition within a given degraded performance category additionally or alternatively may be weighted relative to one or more other degraded performance categories, such as based upon a predetermined preference and/or value metric. That is, in such examples, the respective penalty components associated with each degraded performance category may be determined in any appropriate manner, such as may be based upon a preference and/or a risk/value assessment by an operator and/or owner of vehicle 10. As an example, the operator of vehicle 10 may prioritize human safety above all other considerations, such that the penalty component associated with each predefined degraded performance condition in a degraded performance category pertaining to risk to human safety (and/or a weight given to each penalty component within such a degraded performance category) is significantly higher than that of other degraded performance categories. Additionally, it is within the scope of the present disclosure that a given predefined degraded performance condition may be included in (e.g., a member of) each of a plurality of distinct degraded performance categories. In such examples, the engine health penalty of an engine 50 exhibiting such a degraded performance condition may include the penalty component associated with each of the plurality of degraded performance categories to which the degraded performance condition belongs.

The foregoing discussion generally relates to examples in which the assigning the engine health score at 220 is performed based upon a momentary operational status of the respective engine 50, such as may be based upon and/or determined from engine status information 144 corresponding to the respective engine 50 at a given (e.g., localized) instance and/or moment in time. However, this is not required, and it is additionally within the scope of the present disclosure that engine health score 172 may be based on one or more previous operational statuses of the respective engine 50. For example, the assigning the engine health score at 220 may include assigning based, at least in part, on one or more prior engine health scores 172 corresponding to the respective engine 50, such as engine health scores 172 as assigned during prior iterations and/or instances of method 200. More specifically, in some examples, and as schematically illustrated in FIG. 1, vehicle propulsion control system 110 is configured to record and store an engine health score history 173 for each respective engine 50. In some such examples, engine health score history 173 of each respective engine 50 includes one or more engine health scores 172 that were assigned to the respective engine 50 (e.g., during one or more iterations of the assigning the engine health score at 220) over a prior time interval (e.g., a predetermined time interval and/or a time interval corresponding to a total operation time of vehicle 10). Accordingly, in some such examples, the assigning the engine health score at 220 is at least partially based upon engine health score history 173 of the respective engine 50.

In some examples, engine health score history 173 additionally or alternatively may include performance condition history information regarding the degraded performance condition of the respective engine 50 as determined in one or more instances (e.g., during one or more iterations of the identifying the degraded performance condition(s) at 224) within the prior time interval. Accordingly, in some such examples, the assigning the engine health score at 220 is based, at least in part, on the performance condition history information. As a more specific example, the identifying the degraded performance condition(s) at 224 of a given engine 50 may include identifying a time-sensitive degraded performance condition, such as a degraded performance condition that may be exacerbated and/or that may cause permanent damage to vehicle 10 and/or to the respective engine 50 if the respective engine 50 continues to operate with such a degraded performance condition for longer than a safety margin time interval. Accordingly, in such an example, the assigning the engine health score 220 may include identifying, from the performance condition history information, a persistence time interval over which the time-sensitive degraded performance condition has been known to be in effect. The assigning the engine health score at 220 thus may include assigning such that engine health score 172 is diminished as the persistence time interval approaches the safety margin time interval.

The assigning the engine status identifier at 240 may include identifying any appropriate qualitative and/or quantitative information characterizing the current operational status of each respective engine 50, such as may be associated with and/or complementary to the engine health score 172 of the respective engine 50. In some examples, and as shown in FIG. 3, the assigning the engine status identifier at 240 includes identifying, at 242, the current operational state of the respective engine 50 from among a listing of a plurality of predefined operational states. Specifically, and as schematically illustrated in FIG. 1, vehicle propulsion control system 110 and/or PEC 120 may include, store, and/or otherwise have access to a listing 178 of a plurality of predefined operational states that may be used to characterize an operational condition of engine 50. As examples, listing 178 of the plurality of predefined operational states may include an inactive state, corresponding to a state in which the respective engine 50 is shut down; an operative state, corresponding to a state in which the respective engine 50 is operating to produce thrust; a startup state, in which the respective engine 50 is actively transitioning from the inactive state toward the operative state; a shutoff state, in which the respective engine 50 is transitioning from the operative state toward the inactive state; and/or a non-operational state, in which the respective engine 50 cannot be transitioned to the operative state (e.g., without damaging the respective engine 50 and/or vehicle 10). In some examples, the plurality of predefined operational states included in listing 178 encompasses a full range of possible operational states of engine 50, such that engine 50 may be described as being in exactly one operational state of the plurality of predefined operational states at a given moment in time.

In some examples, one or more predefined operational states of a given engine 50 may be characterized in terms of engine health score 172 characterizing the given engine 50. As an example, a given engine 50 may be described as being in the non-operational state when engine health score 172 of the given engine 50 is below a threshold operational engine health score. Stated differently, in such an example, if the assigning the engine health score at 220 for a given engine 50 yields engine health score 172 of the given engine 50 that is below the threshold operational heath score, the assigning the engine status identifier at 240 for the given engine 50 corresponds to identifying engine status identifier 174 of the given engine 50 as representing the non-operational state.

The foregoing discussion generally relates to examples in which the assigning the engine status identifier at 240 is performed based upon a momentary operational status of the respective engine 50, such as may be based upon and/or determined from engine status information 144 corresponding to the respective engine 50 at a given (e.g., localized) moment in time. However, this is not required, and it is additionally within the scope of the present disclosure that engine status identifier 174 may be based on one or more previous operational statuses of the respective engine 50. For example, the assigning the engine status identifier at 240 may include assigning based, at least in part, on one or more prior engine status identifiers 174 corresponding to the respective engine 50, such as engine status identifiers 174 as assigned during prior iterations and/or instances of method 200. More specifically, in some examples, and as schematically illustrated in FIG. 1, vehicle propulsion control system 110 is configured to record and store a respective engine status identifier history 175 for each respective engine 50. In some such examples, engine status identifier history 175 includes one or more engine status identifiers 175 that were assigned to the respective engine 50 (e.g., during one or more iterations of the assigning the engine status identifier at 240) over a prior time interval (e.g., a predetermined time interval and/or a time interval corresponding to a total available amount of data). Accordingly, in some such examples, the assigning the engine status identifier at 240 is at least partially based upon engine status identifier history 175 of the respective engine 50. As an example, the engine status identifier history 175 of a given engine 50 may indicate that the given engine 50 previously was identified as being in the non-operational state, and the assigning the engine status identifier at 240 to the given engine 50 thus may include automatically determining that engine status identifier 174 of the given engine 50 still represents the non-operational state on account of an inability of the given engine 50 to exit the non-operational state.

Upon completion of the assigning the engine health score at 220 and the assigning the engine status identifier at 240 for each engine 50, vehicle propulsion control system 110 and/or PEC 120 may record and/or store engine health score 172 and engine status identifier 174 for each engine 50 in order to perform the subsequent comparing the operational fitness of the engines at 250. As an example, FIG. 1 schematically illustrates an example in which vehicle propulsion control system 110 and/or PEC 120 records and/or stores an engine-engine health matrix 170 that includes engine health score 172 and engine status identifier 174 for each engine 50 as determined based on the receiving the engine status information at 210. Accordingly, in such examples, each of engine health score history 173 and/or engine status identifier history 175 may include and/or be respective portions of engine-engine health matrix 170 as recorded and/or stored at each iteration of method 200. However, this is not required, and it is within the scope of the present disclosure that vehicle propulsion control system 110 and/or PEC 120 may record and/or store each engine health score 172 and each engine status identifier 174 in any appropriate manner and/or form to enable the comparing the operational fitness of the engines at 250, as described herein.

In some examples, and as shown in FIG. 3, the comparing the operational fitness of the two or more engines at 250 includes comparing, at 252, engine health scores 172 of each of the two or more engines 50. More specifically, in some such examples, the comparing the engine health scores of the two or more engines at 252 includes ranking at least a subset of the plurality of engines 50 in order of decreasing engine health score 172.

Additionally or alternatively, in some examples, and as shown in FIG. 3, the comparing the operational fitness of the two or more engines at 250 includes identifying, at 254, an operative subset of engines of the plurality of engines 50 to be utilized to propel vehicle 10 in view of the operational state of each engine 50 of the plurality of engines 50. Examples of the operative subset of engines are disclosed herein with reference to operative subset of engines 52, as schematically illustrated in FIG. 1. Accordingly, in such examples, the identifying the operative subset of engines at 254 generally includes identifying such that engine health score 172 of each engine 50 in the operative subset of engines 52 is equal to or greater than the threshold operational engine health score. Similarly, in some examples, and as shown in FIG. 3, the comparing the operational fitness of the two or more engines at 250 includes identifying, at 260, a non-operational subset of engines that are not to be utilized to propel vehicle 10. Examples of the non-operational subset of engines are disclosed herein with reference to non-operational subset of engines 54, as schematically illustrated in FIG. 1. Specifically, in some such examples, the identifying the non-operational subset of engines at 260 includes identifying such that engine health score 172 of each engine 50 in the non-operational subset of engines 54 whose engine health score 172 is less than the threshold operational engine health score. More specifically, in such examples, the identifying the non-operational subset of engines at 260 includes assigning every engine 50 whose engine health score 172 is less than the threshold operational engine health score to non-operational subset of engines 54.

In some examples, the identifying the operative subset of engines at 254 may include identifying all engines 50 of the plurality of engines 50 whose respective engine health score 172 does not correspond to engine status identifier 174 indicating the non-operational state and thereby defining the operative subset of engines 52 as including all such engines 50. Stated differently, in such examples, the identifying the operative subset of engines at 254 includes defining operative subset of engines 52 to include every engine 50 with a respective engine health score 172 that is at least equal to the threshold operational engine health score However, this is not required, and it is additionally within the scope of the present disclosure that the identifying the operative subset of engines at 254 includes defining the operative subset of engines 52 to include fewer than all engines 50 whose respective engine health scores 172 are at least equal to the threshold operational engine health score. In this manner, in some examples, one or more engines 50 of the plurality of engines 50 may be in neither of operative subset of engines 52 or non-operational subset of engines 54. In such examples, such engines 50 may be described as being inactive but operable to produce thrust if needed.

In some examples, and as shown in FIG. 3, the identifying the operative subset of engines at 254 includes receiving, at 256, a commanded thrust output signal from a vehicle control director such that commanded thrust output signal 102 corresponds to a commanded total thrust output magnitude to be produced by the plurality of engines 50. Examples of the vehicle control director and/or the commanded thrust output signal are disclosed herein with reference to vehicle control director 100 and commanded thrust output signal 102, respectively, as schematically illustrated in FIG. 1. Stated differently, in such examples, commanded thrust output signal 102 corresponds to (e.g., is indicative of) a total thrust output of engines 50 that is required to perform an action and/or maneuver as directed by vehicle control director 100, and/or by a human operator that utilizes vehicle control director 100. In such examples, and as shown in FIG. 3, the identifying the operative subset of engines at 254 further includes determining, at 258, a number of engines 50 to be included in operative subset of engines 52 based, at least in part, on commanded thrust output signal 102. More specifically, in some such examples, the determining the number of engines at 258 includes determining a minimum number of engines 50 that are required to collectively produce the commanded total thrust output magnitude.

As a more specific example, the determining the number of engines at 258 may result in a determination that the minimum number of engines 50 required to collectively produce the commanded total thrust output magnitude is smaller than the number of engines 50 whose respective engine health score 172 is at least equal to the threshold operational engine health score. In some such examples, the identifying the operative subset of engines at 254 may include defining the operative subset of engines 52 to include every engine 50 with a respective heath score 172 that is at least equal to the threshold heath score, such that each engine 50 in the operative subset of engines 52 may be operated at less than a maximum thrust output. Stated differently, in such an example, the determining the number of engines at 258 may include identifying a total number of engines 50 of vehicle 10 that are not in the non-operational state such that the number of engines 50 in the operative subset of engines 52 is equal to the number of engines 50 that are operational (i.e., not in the non-operational state). Alternatively, the identifying the operative subset of engines at 254 may include defining the operative subset of engines 52 to include fewer than all engines 50 whose respective engine health score 172 is at least equal to the threshold engine health score. In this manner, the identifying the operative subset of engines at 254 and the identifying the non-operational subset of engines at 260 may result in one or more engines 50 being in neither of operative subset of engines 52 or non-operational subset of engines 54.

As another example, the determining the number of engines at 258 may result in a determination that the minimum number of engines 50 required to collectively produce the commanded total thrust output magnitude is greater than the number of engines 50 whose respective engine health score 172 is at least equal to the threshold operational engine health score. In some such examples, and as shown in FIG. 3, method 200 further includes transmitting, at 262, an insufficient thrust error signal to vehicle control director 100. Examples of the insufficient thrust error signal are disclosed herein with reference to insufficient thrust error signal 126, as schematically illustrated in FIG. 1. Accordingly, in such examples, upon receipt of insufficient thrust error signal 126, vehicle control director 100 (and/or a human operator thereof) subsequently may deliver a revised commanded thrust output signal 102 to vehicle propulsion control system 110 and/or PEC 120 corresponding to an amended commanded total thrust output magnitude. Additionally or alternatively, in such examples, the modulating the operational configuration of the engine(s) at 270 may include operating each engine 50 in operative subset of engines 52 at a maximum thrust capacity even if the total thrust magnitude produced by each engine 50 in the operative subset of engines 52 remains lower than the commanded total thrust output magnitude.

The modulating the operational configuration of the engine(s) at 270 may include controlling one or more engines 50 of vehicle 10 in any appropriate manner, such as to meet a commanded total thrust output magnitude and/or to avoid damage to vehicle 10 and/or to one or more engines 50. As used herein, the term “operational configuration,” as used to describe a given engine 50, generally refers to any appropriate present operational descriptors of the given engine 50, such as the operational state of the given engine 50 (e.g., operative, inactive, etc.) and/or a thrust magnitude that presently is being produced by the given engine 50.

In some examples, the identifying the operative subset of engines at 254 may include identifying one or more engines 50 as being in operative subset of engines 52 (i.e., such that such engines will be utilized to produce thrust, e.g., upon subsequently performing the modulating the operational configuration of the engine(s) at 250) while such engines 50 presently are not in the operative state. As a more specific example, one or more engines 50 in operative subset of engines 52 may be in a state in which such engines are not immediately operative to produce thrust, such as the inactive state or the shutoff state. In some such examples, and as shown in FIG. 3, the modulating the operational configuration of the engine(s) at 270 includes, for each engine 50 of operative subset of engines 52 that is not presently in the operative state, transitioning, at 272, each such engine 50 to the operative state. As a more specific example, the identifying the operative subset of engines at 254 may include determining that a given engine 50 is to be included in operative subset of engines 52 when the given engine 50 previously had been shut down. For example, the given engine 50 previously may have been shut down due to a degraded performance condition of the given engine 50 corresponding to engine health score 172 of the given engine 50 being between the threshold engine health score and the optimal engine health score. In such an example, the transitioning the engine(s) to the operative state at 272 may include transitioning the given engine 50 to the operative state such that the given engine 50 contributes to meeting the commanded total thrust output magnitude. In this manner, vehicle propulsion control systems 110 and methods 200 according to the present disclosure may be configured to utilize one or more engines 50 to produce thrust so long as such engines 50 are capable of producing thrust, even if such engines suffer from a degraded performance condition that may motivate disabling such engines 50 if their use is not necessitated.

In some examples, and as discussed, the modulating the operational configuration of the engine(s) at 270 includes controlling one or more engines 50 so as to meet the commanded total thrust output magnitude. More specifically, in some examples, and as shown in FIG. 3, the modulating the operational configuration of the engine(s) at 270 includes adjusting, at 274, a respective thrust output of one or more engines 50 in operative subset of engines 52 such that the total thrust output of operative subset of engines 52 is at least substantially equal to the commanded total thrust output magnitude. In some examples, the adjusting the respective thrust output(s) at 274 includes adjusting such that each respective engine 50 of operative subset of engines 52 produces at least substantially the same thrust. Additionally or alternatively, in some examples, the adjusting the respective thrust output(s) at 274 includes adjusting such that the respective thrust output of each respective engine 50 of operative subset of engines 52 is at least partially based upon the respective engine health score 172 of the respective engine 50. As a more specific example, operative subset of engines 52 may include a first engine 50 and a second engine 50 such that engine health score 172 of the first engine 50 is higher than engine health score 172 of the second engine 50. In such an example, the adjusting the respective thrust output(s) at 274 may include adjusting such that the first engine 50 produces a greater thrust output than the second engine 50, such as to reduce a risk of exacerbating a degraded performance condition of the second engine 50 and/or to reduce a risk of damage to vehicle 10.

In some examples, and as shown in FIG. 3, the modulating the operational configuration of the engine(s) at 270 may include selectively shutting down one or more engines 50. More specifically, in some examples, the modulating the operational configuration of the engine(s) at 270 includes, for each engine 50 of non-operational subset of engines 54 that is in the startup state and/or the operative state, transitioning, at 276, the engine 50 to the shutoff state and/or to the inactive state. As a more specific example, and as discussed, the comparing the operational fitness of the engines at 250 may include the identifying the non-operational subset of engines at 260 such that engine health score 172 of each engine 50 in non-operational subset of engines 54 is less than the threshold operational health score. Stated differently, each engine 50 in non-operational subset of engines 54 may be described as experiencing one or more degraded performance conditions that lead to the determination that such engines 50 are not to be utilized to produce thrust. Accordingly, when one or more engines 50 are identified as being in non-operational subset of engines 54 and also are presently in an active state such as the operative state or the startup state, the modulating the operational configuration of the engine(s) at 270 may include transitioning the engines to or toward the inactive state. In this manner, the transitioning the engine(s) to the shutoff and/or inactive state at 276 may serve to reduce a risk of exacerbating a degraded performance condition of the second engine 50 and/or to reduce a risk of damage to vehicle 10.

The modulating the operational configuration of the engine(s) at 270 may be performed in any appropriate manner. In some examples, the modulating the operational configuration of the engine(s) at 270 is performed by vehicle propulsion control system 110 and/or by PEC 120. More specifically, in some examples, and as shown in FIG. 3, the modulating the operational configuration of the engine(s) at 270 includes generating, at 278, at least one engine action signal for controlling the operation of engine(s) 50, and transmitting, at 280, engine action signal(s) to corresponding EEC(s) 130. Examples of the engine action signal are disclosed herein with reference to engine action signal 124, as schematically illustrated in FIG. 1. That is, in such examples, and as schematically illustrated in FIG. 1, the generating the engine action signal(s) at 278 may include generating a respective engine action signal 124 for each respective engine 50 of at least a subset of the plurality of engines 50 of vehicle 10, and the transmitting the engine action signal(s) at 280 may include transmitting each respective engine action signal 124 to the respective EEC 130 corresponding to the respective engine 50. In such examples, each engine action signal 124 may include and/or be an instruction and/or command to modulate the operational configuration of the respective engine 50 in any appropriate manner, as described herein. As an example, engine action signal 124 may include a command to increase and/or decrease a thrust of the respective engine 50, such as by increasing and/or decreasing the respective fuel flow 152 to the respective engine with the respective fuel control unit 150. Additionally or alternatively, engine action signal 124 may include a command to increase and/or decrease a spool speed associated with the respective engine 50, such as the N1 speed and/or the N2 speed of the respective engine 50. As another example, engine action signal 124 may include a command to engage and/or operate a fault suppressor system associated with the respective engine 50, such as a system for addressing and/or suppressing a degraded performance condition of the respective engine 50. As an example, the fault suppressor system may include and/or be a fire suppressor system.

As another example, in an example in which the modulating the operational configuration of the engine(s) at 270 includes the transitioning one or more engines to the operative state at 272, engine action signal 124 may include a command to transition the respective engine 50 to the operative state, or a command to transition the respective engine 50 to the startup state such that the respective engine 50 subsequently will transition to the operative state. Similarly, in an example in which the modulating the operational configuration of the engine(s) at 270 includes the transitioning one or more engines to the shutoff state and/or the inactive state, engine action signal 124 may include a command to transition the respective engine 50 to the inactive state, or a command to transition the respective engine 50 to the shutoff state such that the respective engine 50 subsequently transitions to the inactive state.

As a more specific example of an application of method 200, Tables 1-4 below represent examples of engine-engine health matrix 170 that may be generated in accordance with a model example in which method 200 is iteratively performed at each of several distinct instances. Stated differently, Tables 1-4 below represent engine health scores 172 and engine status identifiers 174 for each engine 50 as assigned, respectively, at the assigning the engine health scores at 220 and at the assigning the engine status identifiers at 240. In this manner, Tables 1-4 represent engine health scores 172 and engine status identifiers 174 prior to the modulating the operational configuration of the engine(s) at 270 that is associated with the same iteration and/or instance of method 200.

In this model example, each engine-engine health matrix 170 is generated by vehicle propulsion control system 110 of vehicle 10 in the form of an aircraft 20 with four engines 50, respectively labeled Engine 1, Engine 2, Engine 3, and Engine 4. Moreover, in this model example, aircraft 20 requires that at least three of the four engines 50 be operational at any given time. Additionally, in this model example, the optimal engine health score is 10, and the threshold operational health score is 3. Table 1 represents engine health scores 172 for each engine 50 (as assigned during the assigning the engine health scores at 220) and engine status identifiers 174 for each engine 50 (as assigned during the assigning the engine status identifiers at 240) as determined upon an iteration of method 200 occurring at a first instance in this model example.

TABLE 1
Engine-engine health matrix 170 at
first instance of model example.

| | Engine 1 | Engine 2 | Engine 3 | Engine 4 |
|---|---|---|---|---|
| Engine Health Score | 10 | 10 | 10 | 10 |
| (172) | | | | |
| Engine Status Identifier | Operative | Operative | Operative | Operative |
| (174) | State | State | State | State |

At the first instance in this model example, each engine 50 has the optimal engine health score, and thus is fully functional and operating with no known degraded performance conditions.

In this model example, performing method 200 at a second instance that is subsequent to the first instance yields an updated engine-engine health matrix 170 as represented in Table 2:

TABLE 2
Engine-engine health matrix 170 at
second instance of model example.

| | Engine 1 | Engine 2 | Engine 3 | Engine 4 |
|---|---|---|---|---|
| Engine Health Score | 10 | 5 | 10 | 10 |
| (172) | | | | |
| Engine Status Identifier | Operative | Operative | Operative | Operative |
| (174) | State | State | State | State |

At the second instance of this model example represented in Table 2, the assigning the engine health score at 220 for Engine 2 has indicated that Engine 2 is experiencing a degraded performance condition of moderate severity (e.g., a low oil level). Because aircraft 20 can operate with as few as three engines 50 in this model example, the comparing the operational fitness of the engines at 250 includes the identifying the operative subset of engines at 254, which in turn includes the determining the number of engines in the operative subset of engines at 258, resulting in identifying that operative subset of engines 52 includes three engines 50. Accordingly, in this model example, the identifying the operative subset of engines at 254 includes selecting the three engines with the highest respective engine health scores 172. Thus, in this model example, the modulating the operational configuration of the engine(s) at 270 includes transitioning Engine 2 to the shutoff state so as to transition Engine 2 to the inactive state.

In this model example, performing method 200 at a third instance that is subsequent to the second instance yields an updated engine-engine health matrix 170 as represented in Table 3:

TABLE 3
Engine-engine health matrix 170 at
third instance of model example.

| | Engine 1 | Engine 2 | Engine 3 | Engine 4 |
|---|---|---|---|---|
| Engine Health Score | 10 | 5 | 10 | 2 |
| (172) | | | | |
| Engine Status Identifier | Operative | Inactive | Operative | Operative |
| (174) | State | State | State | State |

At the third instance of this model example represented in Table 3, Engine 2 is in the inactive state as previously commanded, but the assigning the engine health score at 220 for Engine 4 has now indicated that Engine 4 is experiencing a degraded performance condition of high severity (e.g., a bird strike), such that engine health score 172 of Engine 4 now is below the threshold operational health score. Accordingly, the identifying the non-operational subset of engines at 260 in this model example includes identifying non-operational subset of engines 54 as including Engine 4. Thus, because Engine 4 is in non-operational subset of engines 54, the modulating the operational configuration of the engine(s) at 270 in this model example includes transitioning Engine 4 to the shutoff state at 276. Additionally, because three engines are required for operation of aircraft 20 (e.g., based upon a commanded total thrust output magnitude), the determining the number of engines in the operative subset of engines at 258 in this model example includes identifying that operative subset of engines 52 includes three engines. Accordingly, because only Engine 1, Engine 2, and Engine 3 have engine health scores 172 that are at least equal to the threshold operational engine health score, the identifying the operative subset of engines at 254 in this model example includes identifying operative subset of engines 52 as including Engine 1, Engine 2, and Engine 3. Thus, because Engine 2 is in the inactive state in this third instance, the modulating the operational configuration of the engine(s) at 270 in this model example includes the transitioning Engine 2 to the operative state at 272. In this model example, the modulating the operational configuration of the engine(s) at 270 additionally may include the adjusting the thrust output of Engine 2 at 274 such that Engine 2 operates at a lower thrust output relative to Engine 1 and Engine 3, such as to avoid exacerbating the degraded performance condition of Engine 2.

In this model example, performing method 200 at a fourth instance that is subsequent to the third instance yields an updated engine-engine health matrix 170 as represented in Table 4:

TABLE 4
Engine-Engine health matrix 170 at
fourth instance of model example.

| | Engine 1 | Engine 2 | Engine 3 | Engine 4 |
|---|---|---|---|---|
| Engine Health Score | 10 | 4 | 10 | 2 |
| (172) | | | | |
| Engine Status Identifier | Operative | Operative | Operative | Inactive |
| (174) | State | State | State | State |

At the fourth instance of this model example represented in Table 4, Engine 2 has been restarted and Engine 4 has been shut down as previously commanded. However, the continued operation of Engine 2 under the effect of the degraded performance condition has slightly exacerbated the degraded performance condition such that engine health score 172 of Engine 2 has decreased to 4. Thus, in this model example, the modulating the operational configuration of the engine(s) at 270 may include the adjusting the thrust output of Engine 2 at 274 in view of its decreased engine health score 172, such as to further reduce the thrust output of Engine 2 relative to Engine 1 and/or Engine 3.

As discussed, methods 200 according to the present disclosure may be performed at least partially, and optionally fully, by vehicle propulsion control system 110 (and/or PEC 120 thereof). In some examples, however, vehicle propulsion control system 110 performs only a portion of methods 200. As an example, vehicle propulsion control system 110 may be configured to perform a subset of methods 200 that pertains to evaluating the operational state of the plurality of engines 50 and to produce recommendations for corresponding actions to be performed by another system and/or a human operator.

More specifically, in some examples, and as shown in FIG. 3, method 200 includes, subsequent to the comparing the operational fitness of the engines at 250, determining, at 264, one or more recommended engine actions based, at least in part, on the comparing the operational fitness of the engines at 250. In such examples, and as shown in FIG. 3, method 200 further includes generating, at 266, a recommended engine action signal that represents the recommended engine actions(s), and transmitting, at 268, the recommended engine action signal to a vehicle control director (such as vehicle control director 100 schematically illustrated in FIGS. 1-2). Examples of the recommended engine action signal are disclosed herein with reference to recommended engine action signal 122, as schematically illustrated in FIG. 1. As a more specific example, and as discussed, vehicle control director 100 may include EICAS 160 that includes user interface 162. In such examples, and as schematically illustrated in FIG. 1, PEC 120 may be configured to transmit recommended engine action signal 122 to vehicle control director 100 and/or to EICAS 160 such that user interface 162 presents the human operator with the recommended engine action.

In some examples, the recommended engine action and/or recommended engine action signal 122 corresponds to engine action signal 124 that otherwise would be provided to each EEC 130 by vehicle propulsion control system 110 in an otherwise identical example in which vehicle propulsion control system 110 performs the modulating the operational configuration of the engine(s) at 270. Stated differently, in some examples, the comparing the operational fitness of the engine(s) at 250 is performed, at least in part, by an autonomous process (such as an autonomous process of vehicle propulsion control system 110 and/or of PEC 120), and the modulating the operational configuration of the engine(s) at 270 is performed by a human operator and at least partially based on recommended engine action signal 122. In such examples, the human operator thus may generate and/or transmit engine action signal 124 to each EEC 130, such as via vehicle propulsion control system 110.

Illustrative, non-exclusive examples of inventive subject matter according to the present disclosure are described in the following enumerated paragraphs:

A1. A method (200) of regulating the operation of a plurality of engines (50) of a vehicle (10), the method (200) comprising:

for each respective engine (50) of the plurality of engines (50):
receiving (210) engine status information (144) regarding an operational status of the respective engine (50);
assigning (220) an engine health score (172) that quantifies an operational fitness of the respective engine (50), based, at least in part, on the engine status information (144); and
assigning (240) an engine status identifier (174) that at least partially represents the current operational state of the respective engine (50) based, at least in part, on the engine status information (144);

comparing (250) the operational fitness of two or more engines (50) of the plurality of engines (50) based, at least in part, on the engine health scores (172) of each of the two or more engines (50); and

modulating (270) an operational configuration of one or more engines (50) of the plurality of engines (50) based, at least in part, on the comparing (250) the operational fitness of the two or more engines (50).

A2. The method (200) of paragraph A1, wherein the method (200) is performed, at least in part, by a vehicle propulsion control system (110) associated with the plurality of engines (50).

A3. The method (200) of any of paragraphs A1-A2, wherein the method (200) is performed, at least in part, by an automated process.

A4. The method (200) of paragraph A3, wherein the comparing (250) the operational fitness of the two or more engines (50) is performed by the automated process.

A5. The method (200) of any of paragraphs A3-A4, wherein the modulating (270) the operational configuration of the one or more engines (50) is performed by the automated process.

A6. The method (200) of any of paragraphs A1-A5, further comprising, subsequent to the comparing (250) the operational fitness of the two or more engines (50):

determining (264) one or more recommended engine actions based, at least in part, on the comparing (250) the operational fitness of the two or more engines (50); and

generating (266) a recommended engine action signal (122) that represents the one or more recommended engine actions; and

transmitting (268) the recommended engine action signal (122) to a vehicle control director (100), optionally to a user interface (162) of the vehicle control director (100).

A7. The method (200) of paragraph A6, wherein the comparing (250) the operational fitness of the two or more engines (50) is performed, at least in part, by an/the autonomous process, and wherein the modulating (270) the operational configuration of the two or more respective engines (50) is performed by a human operator based, at least in part, on the recommended engine action signal (122).

A8. The method (200) of any of paragraphs A1-A7, wherein the receiving (210) the engine status information (144) includes receiving (212) a sensor data signal (142) that is generated by an engine sensor (140) that is configured to detect an operational characteristic of the respective engine (50); wherein the sensor data signal (142) at least partially characterizes the operational characteristic of the respective engine (50).

A9. The method (200) of paragraph A8, wherein the engine status information (144) includes the sensor data signal (142), optionally a plurality of sensor data signals (142) generated by a corresponding plurality of engine sensors (140) associated with the respective engine (50).

A10. The method (200) of any of paragraphs A8-A9, wherein the engine sensor (140) includes one or more of a rotational speed sensor, an air speed sensor, a temperature sensor, a vibration sensor, a pressure sensor, a microphone, a camera, and an infrared camera.

A11. The method (200) of any of paragraphs A8-A10, wherein the operational characteristic includes one or more of a low pressure spool speed (e.g., N1 speed) of the respective engine (50), a high pressure spool speed (e.g., N2 speed) of the respective engine (50), an exhaust gas temperature (EGT) of an exhaust flow exiting the respective engine (50), a radiative temperature produced by a component of the respective engine (50), a vibration magnitude of a component of the respective engine (50), an oil pressure associated with the respective engine (50), and an acoustic noise produced by the respective engine (50).

A12. The method (200) of any of paragraphs A8-A11, wherein the receiving (210) the engine status information (144) includes receiving the engine status information (144) directly from the engine sensor (140).

A13. The method (200) of any of paragraphs A8-A12, wherein the receiving (210) the engine status information (144) includes receiving the engine status information (144) from the engine sensor (140) via an electronic engine controller (EEC) (130) that controls the operation of the respective engine (50).

A14. The method (200) of any of paragraphs A1-A13, wherein the engine health score (172) of each respective engine (50) is one or more of a one-dimensional numerical quantity, a scalar numerical quantity, a real number, an integer, and a percentage.

A15. The method (200) of any of paragraphs A1-A14, wherein the engine health score (172) of the respective engine (50) is positively correlated to the operational fitness of the respective engine (50).

A16. The method (200) of any of paragraphs A1-A15, wherein the engine health score (172) of the respective engine (50) is equal to a predetermined optimal engine health score when the respective engine (50) is fully functional.

A17. The method (200) of paragraph A16, wherein the assigning (220) the engine health score (172) includes:

determining (222) an engine health penalty corresponding to one or more degraded performance conditions of the respective engine (50); and

producing (230) the engine health score (172) based, at least in part, on the engine health penalty and the optimal engine health score, optionally by subtracting the engine health penalty from the optimal engine health score.

A18. The method (200) of paragraph A17, wherein the determining (222) the engine health penalty includes:

identifying (224) the one or more degraded performance conditions from among a listing (176) of a plurality of predefined degraded performance conditions, optionally based on a/the sensor data signal (142);

determining (226) a respective penalty component associated with each of the one or more degraded performance conditions; and

producing (228) the engine health penalty by summing the respective penalty components associated with each of the one or more degraded performance conditions.

A19. The method (200) of paragraph A18, wherein the plurality of predefined degraded performance conditions includes one or more of:

(i) an engine overheat condition;

(ii) an engine surge condition;

(iii) an engine fire condition;

(iv) an engine damage condition;

(v) an engine oil pressure condition; and

(vi) a fuel leak condition.

A20. The method (200) of any of paragraphs A18-A19, wherein the listing (176) of the plurality of predefined degraded performance conditions includes a listing of the respective penalty components associated with each of the plurality of predefined degraded performance conditions; and wherein the determining (226) the respective penalty components includes identifying the respective penalty components from the listing (176) of the plurality of predefined degraded performance conditions.

A21. The method (200) of any of paragraphs A18-A20, wherein the listing (176) of the plurality of predefined degraded performance conditions includes a plurality of degraded performance categories; wherein each degraded performance category of the plurality of degraded performance categories includes a respective subset of the plurality of predefined degraded performance conditions; and wherein the penalty component associated with each respective predefined degraded performance condition is based, at least in part, on the identity of the degraded performance category of the plurality of degraded performance categories that includes the respective predefined degraded performance condition.

A22. The method (200) of paragraph A21, wherein the respective penalty component associated with each respective predefined degraded performance condition within a given degraded performance category of the plurality of degraded performance categories is one or both of:

(i) a number that is specific to the given degraded performance category; and

(ii) a number within a range of numbers that is specific to the given degraded performance category.

A23. The method (200) of any of paragraphs A21-A22, wherein the plurality of degraded performance categories includes categories relating to one or more of:

(i) an anticipated future service lifetime of the respective engine (50) if the respective engine (50) is operated while degraded performance condition remains in effect;

(ii) an impact of the degraded performance condition on a maximum sustained thrust that can be produced by the respective engine (50) if the respective engine (50) is operated while degraded performance condition remains in effect;

(iii) a potential impact of the degraded performance condition on human safety if the respective engine (50) is operated while degraded performance condition remains in effect;

(iv) a potential for serious damage to the respective engine (50) if the respective engine (50) is operated while degraded performance condition remains in effect; and

(v) an anticipated economic impact upon an operator of the vehicle (10) if the respective engine (50) is operated while degraded performance condition remains in effect.

A24. The method (200) of any of paragraphs A21-A23, wherein the respective penalty component associated with each respective predefined degraded performance condition is based, at least in part, on a severity of the respective predefined degraded performance condition.

A25. The method (200) of any of paragraphs A1-A24, wherein the assigning (220) the engine health score (172) of the respective engine (50) includes assigning based, at least in part, on one or more prior engine health scores (172) of the respective engine (50).

A26. The method (200) of paragraph A25, wherein a/the vehicle propulsion control system (110) is configured to record and store, for each respective engine (50) of the plurality of engines (50), an engine health score history (173) that includes one or more engine health scores (172) assigned to the respective engine (50) over a prior time interval, and wherein the assigning (220) the engine health score (172) of the respective engine (50) is based, at least in part, on the engine health score history (173) of the respective engine (50).

A27. The method (200) of paragraph A26, when dependent from paragraph A17, wherein the engine health score history (173) includes performance condition history information regarding the degraded performance condition of the respective engine (50) as determined in one or more instances within the prior time interval, and wherein the assigning (220) the engine health score (172) of the respective engine (50) includes assigning based, at least in part, on the performance condition history information.

A28. The method (200) of any of paragraphs A1-A27, wherein the assigning (240) the engine status identifier (174) includes identifying (242) the current operational state of the respective engine (50) from among a listing (178) of a plurality of predefined operational states.

A29. The method (200) of paragraph A28, wherein the plurality of predefined operational states includes one or more of:

(i) an inactive state, in which the respective engine (50) is shut down;

(ii) an operative state, in which the respective engine (50) is operating to produce thrust;

(iii) a startup state, in which the respective engine (50) is transitioning from the inactive state toward the operative state;

(iv) a shutoff state, in which the respective engine (50) is transitioning from the operative state toward the inactive state; and

(v) a non-operational state, in which the respective engine (50) cannot be transitioned to the operative state.

A30. The method (200) of paragraph A29, wherein a given engine (50) of the plurality of engines (50) is in the non-operational state when the engine health score (172) of the given engine (50) is below a threshold operational engine health score.

A31. The method (200) of any of paragraphs A1-A30, wherein the assigning (240) the engine status identifier (174) includes assigning based, at least in part, on one or more prior engine status identifiers (174) of the respective engine 50).

A32. The method (200) of paragraph A31, wherein a/the vehicle propulsion control system (110) is configured to record and store, for each engine (50) of the plurality of engines (50), an engine status identifier history (175) that includes each engine status identifier (174) assigned to the respective engine (50) over a/the prior time interval, and wherein the assigning (240) the engine status identifier (174) of the respective engine (50) is based, at least in part, on the engine status identifier history (175) of the respective engine (50).

A33. The method (200) of any of paragraphs A1-A32, wherein the comparing (250) the operational fitness of the two or more engines (50) includes comparing (252) the engine health scores (172) of each of the two or more engines (50).

A34. The method (200) of paragraph A33, wherein the comparing (252) the engine health scores (172) of each of the two or more engines (50) includes ranking at least a subset of the plurality of engines (50) in order of decreasing engine health score (172).

A35. The method (200) of any of paragraphs A1-A34, wherein the comparing (250) the operational fitness of the two or more engines (50) includes identifying (254) an operative subset of engines (52) of the plurality of engines (50) such that the engine health score (172) of each engine (50) of the operative subset of engines (52) is equal to or greater than a/the threshold operational engine health score.

A36. The method (200) of paragraph A35, wherein the identifying (254) the operative subset of engines (52) includes:

receiving (256), from a vehicle control director (100), a commanded thrust output signal (102) corresponding to a commanded total thrust output magnitude to be produced by the plurality of engines (50); and

determining (258) a number of engines (50) to be included in the operative subset of engines (52) based, at least in part, on the commanded thrust output signal (102).

A37. The method (200) of paragraph A36, wherein the determining (258) the number of engines (50) to be included in the operative subset of engines (52) includes determining a minimum number of engines (50) that are required to collectively produce the commanded total thrust output magnitude.

A38. The method (200) of paragraph A37, wherein the minimum number of engines (50) required to collectively produce the commanded total thrust output magnitude exceeds the number of engines (50) of the plurality of engines (50) that are not in a/the non-operational state; and wherein the method (200) further includes transmitting (262), to the vehicle control director (100), an insufficient thrust error signal (126).

A39. The method (200) of any of paragraphs A36-A38, wherein the determining (258) the number of engines (50) to be included in the operative subset of engines (52) includes identifying a total number of engines (50) that are not in a/the non-operational state.

A40. The method (200) of any of paragraphs A1-A39, wherein the comparing (250) the operational fitness of the two or more engines (50) includes identifying (260) a non-operational subset of engines (54) of the plurality of engines (50) such that the engine health score (172) of each engine (50) of the non-operational subset of engines (54) is less than a/the threshold operational engine health score.

A41. The method (200) of any of paragraphs A1-A40, wherein the modulating (270) the operational configuration of the one or more engines (50) includes, for each engine (50) of a/the operative subset of engines (52) not presently in a/the operative state, transitioning (272) the engine (50) to the operative state.

A42. The method (200) of any of paragraphs A1-A41, wherein the modulating (270) the operational configuration of the one or more engines (50) includes adjusting (274) a respective thrust output of one or more engines (50) in the operative subset of engines (52) such that the total thrust output of the operative subset of engines (52) is at least substantially equal to a/the commanded total thrust output magnitude.

A43. The method (200) of paragraph A42, wherein the adjusting (274) the respective thrust output of the one or more engines (50) includes adjusting such that each respective engine (50) of the operative subset of engines (52) produces at least substantially the same thrust.

A44. The method (200) of any of paragraphs A42-A43, wherein the adjusting (274) the respective thrust output of the one or more engines (50) includes adjusting such that the respective thrust output of each respective engine (50) of the operative subset of engines (52) is based, at least in part, on the respective engine health score (172) of the respective engine (50).

A45. The method (200) of any of paragraphs A1-A44, wherein the modulating (270) the operational configuration of the one or more engines (50) includes, for each engine (50) of a/the non-operational subset of engines (54) that is in one or both of a/the startup state and a/the operative state, transitioning (276) the engine (50) to one or both of a/the shutoff state and a/the inactive state.

A46. The method (200) of any of paragraphs A1-A45, wherein the modulating (270) the operational configuration of the one or more engines (50) includes:

generating (278) at least one engine action signal (124) for controlling the operation of the one or more engines (50); and

transmitting (280) the at least one engine action signal (124) to a corresponding at least one EEC (130).

A47. The method (200) of paragraph A46, wherein each engine action signal (124) includes a command to one or more of:

(i) increase and/or decrease a respective fuel flow (152) to the respective engine (50);

(ii) increase and/or decrease an/the N1 speed and/or an/the N2 speed of the respective engine (50);

(iii) increase and/or decrease a thrust output of the respective engine (50);

(iv) engage a fault suppressor system associated with the respective engine (50);

(v) transition the respective engine (50) to one or both of a/the operative state and a/the startup state; and

(vi) transition the respective engine (50) to one or both of a/the inactive state and a/the shutoff state.

B1. A vehicle propulsion control system (110) for controlling the operation of a plurality of engines (50) of a vehicle (10), the vehicle propulsion control system (110) comprising a propulsion executive controller (PEC) (120) configured to execute at least a portion of the method (200) of any of paragraphs A1-A47.

B2. The vehicle propulsion control system (110) of paragraph B1, wherein the vehicle (10) comprises a plurality of electronic engine controllers (EECs) (130); wherein each EEC (130) is configured to control the operation of a respective engine (50) of the plurality of engines (50); and wherein the PEC (120) is configured to generate and transmit an/the engine action signal (124) to each EEC (130) based, at least in part, on the respective engine health scores (172) of two or more engines (50) of the plurality of engines (50).

B2.1, The vehicle propulsion control system (110) of paragraph B2, wherein each engine (50) of the plurality of engines (50) includes a respective EEC (130) of the plurality of EECs (130).

B2.2 The vehicle propulsion control system (110) of any of paragraphs B2-B2.1, further comprising the plurality of EECs (130).

B3. The vehicle propulsion control system (110) of any of paragraphs B2-B2.2, wherein each EEC (130) is the EEC (130) of any of paragraphs A13-A47.

B4. The vehicle propulsion control system (110) of any of paragraphs B2-B3, wherein the PEC (120) is configured to transmit a respective engine action signal (124) to a respective EEC (130) of the plurality of EECs (130) based, at least in part, on the engine health score (172) of a particular engine (50) of the plurality of engines (50) that is not controlled by the respective EEC (130).

B5. The vehicle propulsion control system (110) of any of paragraphs B1-B4, further comprising one or more engine sensors (140); wherein each engine sensor (140) of the plurality of engine sensors (140) is configured to:

(i) detect a/the respective operational characteristic of a respective one or more engines (50) of the plurality of engines (50);

(ii) generate a/the respective sensor data signal (142) that at least partially characterizes the respective operational characteristic; and

(iii) transmit the respective sensor data signal (142) to the PEC (120), optionally via a/the respective EEC (130).

B6. The vehicle propulsion control system (110) of paragraph B5, wherein each engine sensor (140) is the engine sensor (140) of any of paragraphs A8-A47.

B7. The vehicle propulsion control system (110) of any of paragraphs B1-B6, further comprising one or more fuel control units (150) for regulating a/the respective fuel flow (152) to each respective engine (50) of the plurality of engines (50).

C1. A vehicle (10), comprising:

a plurality of engines (50); and

the vehicle propulsion control system (110) of any of paragraphs B1-B7.

C2. The vehicle (10) of paragraph C1, wherein the vehicle (10) is a fully autonomous vehicle (10).

C3. The vehicle (10) of any of paragraphs C1-C2, wherein the vehicle (10) is an aircraft (20).

C4. The vehicle (10) of any of paragraphs C1-C3, wherein the vehicle (10) is configured to be at least partially operated by a human operator.

C5. The vehicle (10) of any of paragraphs C1-C4, further comprising a/the vehicle control director (100) for at least partially controlling operation of the vehicle propulsion control system (110).

C6. The vehicle (10) of paragraph C5, wherein the vehicle control director (100) includes an engine-indicating and crew-alerting system (EICAS) (160) configured to provide information to a/the human operator regarding operation of the plurality of engines (50).

C7. The vehicle (10) of paragraph C6, when dependent from paragraph A6, wherein the EICAS (160) includes the user interface (162), and wherein the PEC (120) is configured to transmit the recommended engine action signal (122) to the EICAS (160) such that the user interface (162) presents the human operator with the recommended engine action.

D1. Non-transitory computer readable storage media including computer-executable instructions that, when executed, direct a vehicle propulsion control system to perform the method of any of paragraphs A1-A47.

As used herein, the phrase “at least substantially,” when modifying a degree or relationship, includes not only the recited “substantial” degree or relationship, but also the full extent of the recited degree or relationship. A substantial amount of a recited degree or relationship may include at least 75% of the recited degree or relationship. For example, a first direction that is at least substantially parallel to a second direction includes a first direction that is within an angular deviation of 22.5° relative to the second direction and also includes a first direction that is identical to the second direction.

As used herein, the terms “selective” and “selectively,” when modifying an action, movement, configuration, or other activity of one or more components or characteristics of an apparatus, mean that the specific action, movement, configuration, or other activity is a direct or indirect result of one or more dynamic processes, as described herein. The terms “selective” and “selectively” thus may characterize an activity that is a direct or indirect result of user manipulation of an aspect of, or one or more components of, the apparatus, or may characterize a process that occurs automatically, such as via the mechanisms disclosed herein.

As used herein, the terms “adapted” and “configured” mean that the element, component, or other subject matter is designed and/or intended to perform a given function. Thus, the use of the terms “adapted” and “configured” should not be construed to mean that a given element, component, or other subject matter is simply “capable of” performing a given function but that the element, component, and/or other subject matter is specifically selected, created, implemented, utilized, programmed, and/or designed for the purpose of performing the function. It is also within the scope of the present disclosure that elements, components, and/or other recited subject matter that is recited as being adapted to perform a particular function may additionally or alternatively be described as being configured to perform that function, and vice versa. Similarly, subject matter that is recited as being configured to perform a particular function may additionally or alternatively be described as being operative to perform that function.

As used herein, the term “and/or” placed between a first entity and a second entity means one of (1) the first entity, (2) the second entity, and (3) the first entity and the second entity. Multiple entries listed with “and/or” should be construed in the same manner, i.e., “one or more” of the entities so conjoined. Other entities optionally may be present other than the entities specifically identified by the “and/or” clause, whether related or unrelated to those entities specifically identified. Thus, as a non-limiting example, a reference to “A and/or B,” when used in conjunction with open-ended language such as “comprising,” may refer, in one example, to A only (optionally including entities other than B); in another example, to B only (optionally including entities other than A); in yet another example, to both A and B (optionally including other entities). These entities may refer to elements, actions, structures, steps, operations, values, and the like.

As used herein, the phrase “at least one,” in reference to a list of one or more entities should be understood to mean at least one entity selected from any one or more of the entities in the list of entities, but not necessarily including at least one of each and every entity specifically listed within the list of entities and not excluding any combinations of entities in the list of entities. This definition also allows that entities may optionally be present other than the entities specifically identified within the list of entities to which the phrase “at least one” refers, whether related or unrelated to those entities specifically identified. Thus, as a non-limiting example, “at least one of A and B” (or, equivalently, “at least one of A or B,” or, equivalently “at least one of A and/or B”) may refer, in one embodiment, to at least one, optionally including more than one, A, with no B present (and optionally including entities other than B); in another embodiment, to at least one, optionally including more than one, B, with no A present (and optionally including entities other than A); in yet another embodiment, to at least one, optionally including more than one, A, and at least one, optionally including more than one, B (and optionally including other entities). In other words, the phrases “at least one,” “one or more,” and “and/or” are open-ended expressions that are both conjunctive and disjunctive in operation. For example, each of the expressions “at least one of A, B, and C,” “at least one of A, B, or C,” “one or more of A, B, and C,” “one or more of A, B, or C,” and “A, B, and/or C” may mean A alone, B alone, C alone, A and B together, A and C together, B and C together, A, B, and C together, and optionally any of the above in combination with at least one other entity.

As used herein, the phrase, “for example,” the phrase, “as an example,” and/or simply the term “example,” when used with reference to one or more components, features, details, structures, embodiments, and/or methods according to the present disclosure, are intended to convey that the described component, feature, detail, structure, embodiment, and/or method is an illustrative, non-exclusive example of components, features, details, structures, embodiments, and/or methods according to the present disclosure. Thus, the described component, feature, detail, structure, embodiment, and/or method is not intended to be limiting, required, or exclusive/exhaustive; and other components, features, details, structures, embodiments, and/or methods, including structurally and/or functionally similar and/or equivalent components, features, details, structures, embodiments, and/or methods, are also within the scope of the present disclosure.

In the present disclosure, several of the illustrative, non-exclusive examples have been discussed and/or presented in the context of flow diagrams, or flow charts, in which the methods are shown and described as a series of blocks, or steps. Unless specifically set forth in the accompanying description, it is within the scope of the present disclosure that the order of the blocks may vary from the illustrated order in the flow diagram, including with two or more of the blocks (or steps) occurring in a different order, concurrently, and/or repeatedly. It is also within the scope of the present disclosure that the blocks, or steps, may be implemented as logic, which also may be described as implementing the blocks, or steps, as logics. In some applications, the blocks, or steps, may represent expressions and/or actions to be performed by functionally equivalent circuits or other logic devices. The illustrated blocks may, but are not required to, represent executable instructions that cause a computer, processor, and/or other logic device to respond, to perform an action, to change states, to generate an output or display, and/or to make decisions.

The various disclosed elements of apparatuses and systems and steps of methods disclosed herein are not required to all apparatuses, systems, and methods according to the present disclosure, and the present disclosure includes all novel and non-obvious combinations and subcombinations of the various elements and steps disclosed herein. Moreover, one or more of the various elements and steps disclosed herein may define independent inventive subject matter that is separate and apart from the whole of a disclosed apparatus, system, or method. Accordingly, such inventive subject matter is not required to be associated with the specific apparatuses, systems, and methods that are expressly disclosed herein and such inventive subject matter may find utility in apparatuses, systems, and/or methods that are not expressly disclosed herein.

It is believed that the disclosure set forth above encompasses multiple distinct inventions with independent utility. While each of these inventions has been disclosed in its preferred form, the specific embodiments thereof as disclosed and illustrated herein are not to be considered in a limiting sense as numerous variations are possible. The subject matter of the inventions includes all novel and non-obvious combinations and subcombinations of the various elements, features, functions and/or properties disclosed herein. Similarly, where the claims recite “a” or “a first” element or the equivalent thereof, such claims should be understood to include incorporation of one or more such elements, neither requiring nor excluding two or more such elements.

It is believed that the following claims particularly point out certain combinations and subcombinations that are directed to one of the disclosed inventions and are novel and non-obvious. Inventions embodied in other combinations and subcombinations of features, functions, elements, and/or properties may be claimed through amendment of the present claims or presentation of new claims in this or a related application. Such amended or new claims, whether they are directed to a different invention or directed to the same invention, whether different, broader, narrower, or equal in scope to the original claims, are also regarded as included within the subject matter of the inventions of the present disclosure.

1. A method of regulating the operation of a plurality of engines of a vehicle, the method comprising:
for each respective engine of the plurality of engines:
receiving engine status information regarding an operational status the respective engine;
assigning an engine health score that quantifies an operational fitness of the respective engine, based, at least in part, on the engine status information; and
assigning an engine status identifier that at least partially represents the current operational state of the respective engine based, at least in part, on the engine status information;
comparing the operational fitness of two or more engines of the plurality of engines based, at least in part, on the engine health scores of each of the two or more engines; and
modulating an operational configuration of one or more engines of the plurality of engines based, at least in part, on the comparing the operational fitness of the two or more engines;
wherein the comparing the operational fitness of the two or more engines includes comparing the engine health scores of each of the two or more engines.

2. The method of claim 1, wherein the method is performed, at least in part, by an automated process.

3. The method of claim 1, wherein the receiving the engine status information includes receiving a sensor data signal that is generated by an engine sensor that is configured to detect an operational characteristic of the respective engine; wherein the sensor data signal at least partially characterizes the operational characteristic of the respective engine.

4. The method of claim 1, wherein the engine health score of each respective engine is a one-dimensional numerical quantity that is equal to a predetermined optimal engine health score when the respective engine is fully functional; and wherein the assigning the engine health score includes:
determining an engine health penalty corresponding to one or more degraded performance conditions of the respective engine; and
producing the engine health score based, at least in part, on the engine health penalty and the optimal engine health score.

5. The method of claim 4, wherein the determining the engine health penalty includes:
identifying the one or more degraded performance conditions from among a listing of a plurality of predefined degraded performance conditions based on a sensor data signal from an engine sensor associated with the respective engine;
determining a respective penalty component associated with each of the one or more degraded performance conditions; and
producing the engine health penalty by summing the respective penalty components associated with each of the one or more degraded performance conditions.

6. The method of claim 5, wherein the listing of the plurality of predefined degraded performance conditions includes a listing of the respective penalty components associated with each of the plurality of predefined degraded performance conditions; and wherein the determining the respective penalty components includes identifying the respective penalty components from the listing of the plurality of predefined degraded performance conditions.

7. The method of claim 5, wherein the listing of the plurality of predefined degraded performance conditions includes a plurality of degraded performance categories; wherein each degraded performance category of the plurality of degraded performance categories includes a respective subset of the plurality of predefined degraded performance conditions; and wherein the respective penalty component associated with each respective predefined degraded performance condition is based, at least in part, on the identity of the degraded performance category of the plurality of degraded performance categories that includes the respective predefined degraded performance condition.

8. The method of claim 7, wherein the respective penalty component associated with each respective predefined degraded performance condition within a given degraded performance category of the plurality of degraded performance categories is one or both of:
(i) a number that is specific to the given degraded performance category; and
(ii) a number within a range of numbers that is specific to the given degraded performance category.

9. The method of claim 5, wherein the respective penalty component associated with each respective predefined degraded performance condition is based, at least in part, on a severity of the respective predefined degraded performance condition.

10. The method of claim 1, wherein the assigning the engine status identifier includes identifying the current operational state of the respective engine from among a listing of a plurality of predefined operational states that includes one or more of:
(i) an inactive state, in which the respective engine is shut down;
(ii) an operative state, in which the respective engine is operating to produce thrust;
(iii) a startup state, in which the respective engine is transitioning from the inactive state toward the operative state;
(iv) a shutoff state, in which the respective engine is transitioning from the operative state toward the inactive state; and
(v) a non-operational state, in which the respective engine cannot be transitioned to the operative state;
wherein a given engine of the plurality of engines is in the non-operational state when the engine health score of the given engine is below a threshold operational engine health score.

11. The method of claim 10, wherein the comparing the operational fitness of the two or more engines includes identifying an operative subset of engines of the plurality of engines such that the engine health score of each engine of the operative subset of engines is equal to or greater than the threshold operational engine health score; and wherein the identifying the operative subset of engines includes:
receiving, from a vehicle control director, a commanded thrust output signal corresponding to a commanded total thrust output magnitude to be produced by the plurality of engines; and
determining a number of engines to be included in the operative subset of engines based, at least in part, on the commanded thrust output signal.

12. The method of claim 11, wherein the determining the number of engines to be included in the operative subset of engines includes determining a minimum number of engines that are required to collectively produce the commanded total thrust output magnitude.

13. The method of claim 11, wherein the modulating the operational configuration of the one or more engines includes, for each engine of the operative subset of engines not presently in the operative state, transitioning the engine to the operative state.

14. The method of claim 11, wherein the modulating the operational configuration of the one or more engines includes adjusting a respective thrust output of one or more engines in the operative subset of engines such that the total thrust output of the operative subset of engines is at least substantially equal to the commanded total thrust output magnitude.

15. The method of claim 14, wherein the adjusting the respective thrust output of each engine includes adjusting such that the respective thrust output of each respective engine is based, at least in part, on the engine health score of the respective engine.

16. The method of claim 10, wherein the comparing the operational fitness of the two or more engines includes identifying a non-operational subset of engines of the plurality of engines such that the engine health score of each engine of the non-operational subset of engines is less than the threshold operational engine health score; and wherein the modulating the operational configuration of the one or more engines includes, for each engine of the non-operational subset of engines that is in one or both of the startup state and the operative state, transitioning the engine to one or both of the shutoff state and the inactive state.

17. The method of claim 1, wherein the modulating the operational configuration of the one or more engines includes:
generating at least one engine action signal for controlling the operation of the one or more engines; and
transmitting the at least one engine action signal to a corresponding at least one electronic engine controller (EEC) that controls the operation of a respective engine of the plurality of engines.

18. A vehicle propulsion control system for controlling the operation of a plurality of engines of a vehicle, the vehicle propulsion control system comprising:
a propulsion executive controller (PEC) configured to execute at least a portion of the method of claim 1; and
a plurality of electronic engine controllers (EECs) such that each EEC of the plurality of EECs controls the operation of a respective engine of the plurality of engines;
wherein the PEC is configured to generate and transmit an engine action signal for controlling the operation of the one or more respective engines to each EEC based, at least in part, on the respective engine health scores of two or more engines of the plurality of engines.

19. The vehicle propulsion control system of claim 18, wherein the PEC is configured to transmit a respective engine action signal to a respective EEC of the plurality of EECs based, at least in part, on the engine health score of a particular engine of the plurality of engines that is not controlled by the respective EEC.

20. An aircraft, comprising:
a plurality of engines; and
the vehicle propulsion control system of claim 18.
